(19) United States
(12) Patent Application Publication
(10) Pub. No.: US 2023/0040135 A1
(43) Pub. Date: Feb. 9, 2023

(54) FLEET ASSIGNMENT BASED ON AN AIRCRAFT AVAILABILITY METRIC

(71) Applicant: The Boeing Company, Chicago, IL (US)

(72) Inventor: Zhennong Wang, Bellevue, WA (US)

(21) Appl. No.: 17/444,436

(22) Filed: Aug. 4, 2021

(51) Int. Cl. G06Q 10/06; G06Q 10/08; G06Q 10/00; B64F 5/60

(52) U.S. Cl. CPC G06Q 10/06312; G06Q 10/06313; G06Q 10/0875; G06Q 10/20; B64F 5/60

(57) ABSTRACT

A method of managing in-service operation of a fleet of aircraft is provided that includes generating a schedule of flights through an air transportation network that includes airports, and that includes direct flight routes or flight connections between the airports. The method includes performing a fleet assignment of the fleet of aircraft to the schedule of flights based on availability metric values for respective aircraft of the fleet of aircraft, and dispatching the fleet of aircraft serve the schedule of flights to according to the fleet assignment. In this regard, performing the fleet assignment includes, for an aircraft of the fleet of aircraft, accessing reliability metric values for parts of the aircraft. Availability scores for the aircraft are determined based on the reliability metric values from respective ones of the data sources, and the availability scores are combined to determine an availability metric value for the aircraft.

### TECHNOLOGICAL FIELD

The present disclosure relates generally to managing in-service operation of a fleet of aircraft and, in particular, to fleet assignment based on an availability metric for aircraft of the fleet.

### BACKGROUND

In-service operation of a fleet of aircraft by an airline or other operator generally includes flight schedule generation, fleet assignment and crew scheduling. This airline scheduling process presents issues for the airline in deciding what aircraft of the fleet to assign to what flights of the schedule. Most airline scheduling solutions are based on those aircraft of the fleet that are available to schedule, as well as crew availability. But these solutions do not address reliability of the aircraft to serve flights of the schedule without an in-service interruption.

In particular, the flight schedules of many airlines include flights to airports without access to necessary facilities to address any maintenance that the aircraft may need. This leads to greater in-service interruptions when an aircraft requires maintenance at one of these airports, as a greater lead time may be needed while the necessary resources for the maintenance are brought to the airport. And the process of bringing the necessary resources may result in a greater cost to the airline.

It would therefore be desirable to have a system and method that takes into account at least some of the issues discussed above, as well as other possible issues.

### BRIEF SUMMARY

Example implementations of the present disclosure are directed to managing in-service operation of a fleet of aircraft and, in particular, to fleet assignment based on an availability metric for aircraft of the fleet. More particularly, example implementations of the present disclosure perform a fleet assignment based on an availability metric that depends on a probability of the aircraft to serve one or more of the flights without an in-service interruption. This probability is expressed by an availability score, and for an aicraft of the fleet, availability scores may be determined based on reliability metric values from data sources with respective, independent systems for encoding the reliability metric values. These data sources may include, for example, a source of part survival analysis, an aircraft logbook, an airplane health management (AHM) system, a minimum equipment list (MEL), or the like.

The present disclosure thus includes, without limitation, the following example implementations.

Some example implementations provide an apparatus for managing in-service operation of a fleet of aircraft, the apparatus comprising a memory configured to store computer-readable program code; and processing circuitry configured to access the memory, and execute the computer-readable program code to cause the apparatus to at least: generate a schedule of flights through an air transportation network that includes airports, and that includes direct flight routes or flight connections between the airports; perform a fleet assignment of the fleet of aircraft to the schedule of flights based on availability metric values for respective aircraft of the fleet of aircraft, performing the fleet assignment including for an aircraft of the fleet of aircraft: access reliability metric values for parts of the aircraft, the reliability metric values accessed from data sources with respective, independent systems for encoding the reliability metric values; determine availability scores for the aircraft based on the reliability metric values from respective ones of the data sources, each availability score expressing a probability of the aircraft to serve one or more of the flights without an in-service interruption; and combine the availability scores to determine an availability metric value for the aircraft; and dispatch the fleet of aircraft serve the schedule of flights to according to the fleet assignment.

Some example implementations provide a method of managing in-service operation of a fleet of aircraft, the method comprising generating a schedule of flights through an air transportation network that includes airports, and that includes direct flight routes or flight connections between the airports; performing a fleet assignment of the fleet of aircraft to the schedule of flights based on availability metric values for respective aircraft of the fleet of aircraft, performing the fleet assignment including for an aircraft of the fleet of aircraft: accessing reliability metric values for parts of the aircraft, the reliability metric values accessed from data sources with respective, independent systems for encoding the reliability metric values; determining availability scores for the aircraft based on the reliability metric values from respective ones of the data sources, each availability score expressing a probability of the aircraft to serve one or more of the flights without an in-service interruption; and combining the availability scores to determine an availability metric value for the aircraft; and dispatching the fleet of aircraft serve the schedule of flights to according to the fleet assignment.

Some example implementations provide a computer-readable storage medium for managing in-service operation of a fleet of aircraft, the computer-readable storage medium being non-transitory and having computer-readable program code stored therein that, in response to execution by processing circuitry, causes an apparatus to at least generate a schedule of flights through an air transportation network that includes airports, and that includes direct flight routes or flight connections between the airports; perform a fleet assignment of the fleet of aircraft to the schedule of flights based on availability metric values for respective aircraft of the fleet of aircraft, performing the fleet assignment including for an aircraft of the fleet of aircraft: access reliability metric values for parts of the aircraft, the reliability metric values accessed from data sources with respective, independent systems for encoding the reliability metric values; determine availability scores for the aircraft based on the reliability metric values from respective ones of the data sources, each availability score expressing a probability of the aircraft to serve one or more of the flights without an in-service interruption; and combine the availability scores to determine an availability metric value for the aircraft; and dispatch the fleet of aircraft serve the schedule of flights to according to the fleet assignment.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates one type of vehicle, namely, an aircraft that may benefit from example implementations of the present disclosure;

FIG. 2 illustrates an aircraft manufacturing and service method, according to some example implementations;

FIG. 3 illustrates a portion of a part survival analysis, according to some example implementations;

FIGS. 4A and 4B illustrate portions of an aircraft logbook, according to some example implementations;

FIGS. 5A and 5B illustrate data from an airplane health management (AHM) system, according to some example implementations;

FIG. 6 illustrates a portion of a minimum equipment list (MEL), according to some example implementations;

FIGS. 7A, 7B, 7C, 7D, 7E and 7F are flowcharts illustrating various steps in a method of managing in-service operation of a fleet of aircraft, according to various example implementations; and

FIG. 8 illustrates an apparatus according to some example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

Example implementations of the present disclosure relate generally to vehicular engineering and, in particular, to one or more of the design, construction, operation or use of vehicles. As used herein, a vehicle is a machine designed as an instrument of conveyance by land, water or air. A vehicle designed and configurable to fly may at times be referred to as an aerial vehicle, an aircraft or the like. Other examples of suitable vehicles include any of a number of different types of ground vehicles (e.g., motor vehicles, railed vehicles), watercraft, amphibious vehicles, spacecraft and the like.

A vehicle generally includes a basic structure, and a propulsion system coupled to the basic structure. The basic structure is the main supporting structure of the vehicle to which other components are attached. The basic structure is the load-bearing framework of the vehicle that structurally supports the vehicle in its construction and function. In various contexts, the basic structure may be referred to as a chassis, an airframe or the like.

The propulsion system includes one or more engines or motors configured to power one or more propulsors to generate propulsive forces that cause the vehicle to move. A propulsor is any of a number of different means of converting power into a propulsive force. Examples of suitable propulsors include rotors, propellers, wheels and the like. In some examples, the propulsion system includes a drivetrain configured to deliver power from the engines/motors to the propulsors. The engines/motors and drivetrain may in some contexts be referred to as the powertrain of the vehicle.

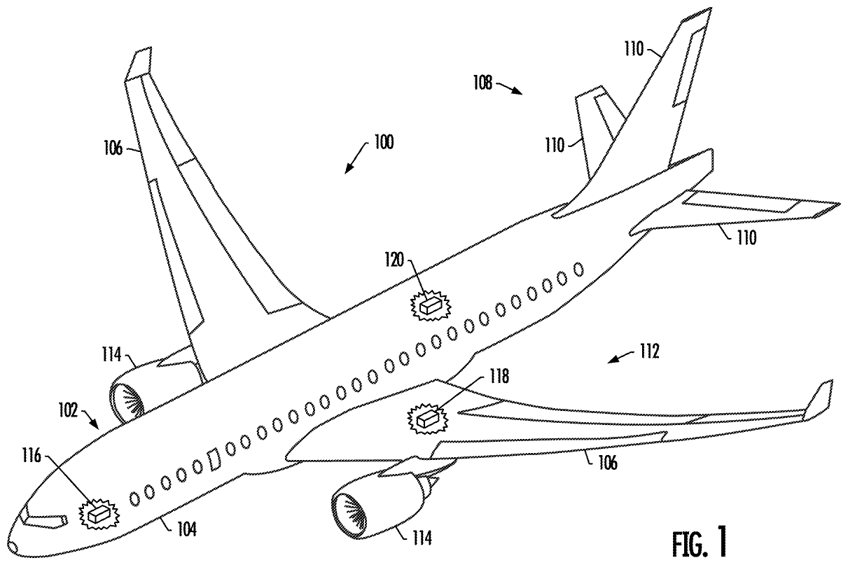

FIG. 1 illustrates one type of vehicle, namely, an aircraft 100 that may benefit from example implementations of the present disclosure. As shown, the aircraft includes a basic structure with an airframe 102 including a fuselage 104. The airframe also includes wings 106 that extend from opposing sides of the fuselage, an empennage or tail assembly 108 at a rear end of the fuselage, and the tail assembly includes stabilizers 110. The aircraft also includes a plurality of high-level systems 112 such as a propulsion system. In the particular example shown in FIG. 1, the propulsion system includes two wing-mounted engines 114 configured to power propulsors to generate propulsive forces that cause the aircraft to move. In other implementations, the propulsion system can include other arrangements, for example, engines carried by other portions of the aircraft including the fuselage and/or the tail. As also shown, the high-level systems may also include an electrical system 116, hydraulic system 118 and/or environmental system 120. Any number of other systems may be included.

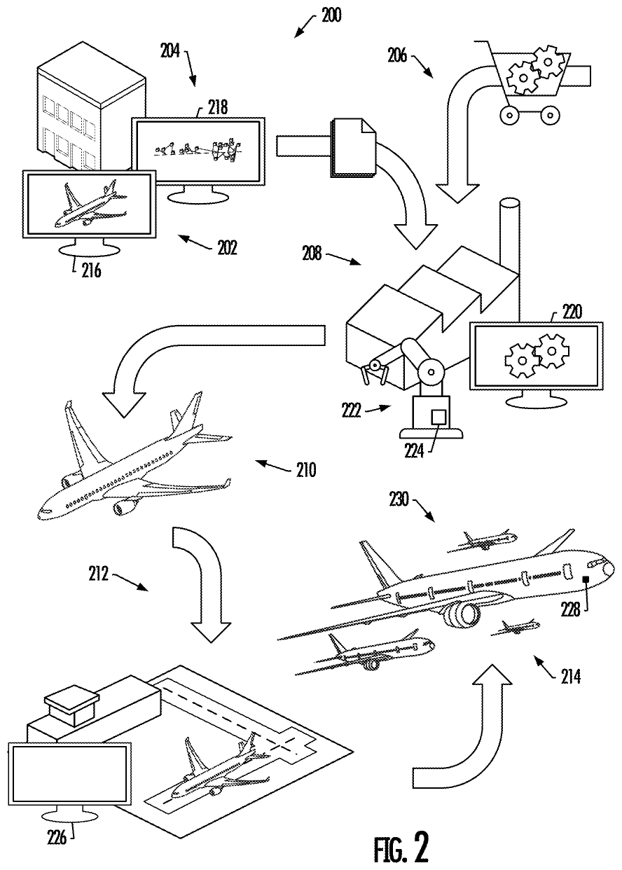

As explained above, example implementations of the present disclosure relate generally to vehicular engineering and, in particular, to one or more of the design, construction, operation or use of vehicles such as aircraft 100. Thus, referring now to FIG. 2, example implementations may be used in the context of an aircraft manufacturing and service method 200. During pre-production, the example method may include specification and design 202 of the aircraft, manufacturing sequence and processing planning 204 and material procurement 206. During production, component and subassembly manufacturing 208 and system integration 210 of the aircraft takes place. Thereafter, the aircraft may go through certification and delivery 212 in order to be placed in service 214. While in service by an airline or other operator, the aircraft may be scheduled for maintenance and service (which may also include modification, reconfiguration, refurbishment or the like).

Each of the processes of the example method 200 may be performed or carried out by a system integrator, third party and/or operator (e.g., customer). For the purposes of this description, a system integrator may include for example any number of aircraft manufacturers and major-system subcontractors; a third party may include for example any number of vendors, subcontractors and suppliers; and an operator may include for example an airline, leasing company, military entity, service organization or the like.

As will also be appreciated, computers are often used throughout the method 200; and in this regard, a “computer” is generally a machine that is programmable to programmed to perform functions or operations. The method as shown makes use of a number of example computers. These computers include computers 216, 218 used for the specification and design 202 of the aircraft, and the manufacturing sequence and processing planning 204. The method may also make use of computers 220 during component and subassembly manufacturing 208, which may also make use of computer numerical control (CNC) machines 222 or other robotics that are controlled by computers 224. Even further, computers 226 may be used while the aircraft is in service 214, as well as during maintenance and service; and as suggested in FIG. 1, the aircraft may itself include one or more computers 228 as part of or separate from its electrical system 116.

A number of the computers 216-228 used in the method 200 may be co-located or directly coupled to one another, or in some examples, various ones of the computers may communicate with one another across one or more computer networks. Further, although shown as part of the method, it should be understood that any one or more of the computers may function or operate separate from the method, without regard to any of the other computers. It should also be understood that the method may include one or more additional or alternative computers than those shown in FIG. 2.

Example implementations of the present disclosure may be implemented throughout the aircraft manufacturing and service method 200, but are particularly well suited for implementation during in-service operation of the aircraft, or more particularly a fleet of aircraft 230. In this regard, some example implementations provide a computer 226 for managing in-service operation of a fleet of aircraft. The computer is configured to generate a schedule of flights through an air transportation network that includes airports, and that includes direct flight routes or flight connections between the airports. The computer is configured to perform a fleet assignment of the fleet of aircraft to the schedule of flights based on availability metric values for respective aircraft of the fleet of aircraft.

According to example implementations of the present disclosure, for an aircraft of the fleet of aircraft 230, the fleet assignment includes the computer 226 configured to access reliability metric values for parts of the aircraft. The reliability metric values are accessed from data sources with respective, independent systems for encoding the reliability metric values. Examples of suitable data sources include a source of part survival analysis, an aircraft logbook, an airplane health management (AHM) system, or a minimum equipment list (MEL) that may be generated based on a master minimum equipment list (MMEL)

FIG. 3 illustrates a portion of a part survival analysis 300, which may be a component of predicting availability of an aircraft according to some example implementations. As shown, data from the part survival analysis may identify parts of the aircraft such as by part number (PN), serial number (SN), short part name (SHRT_PART_NM), ATA 100 classification, aircraft type and/or aircfraft identification number (AC). Data from which part survival is determined may include a time since new (TSN), cycles since new (CSN) and the like. This data may be compared against historical data for the respective parts, then, to determine reliability metric values as survivability of the parts.

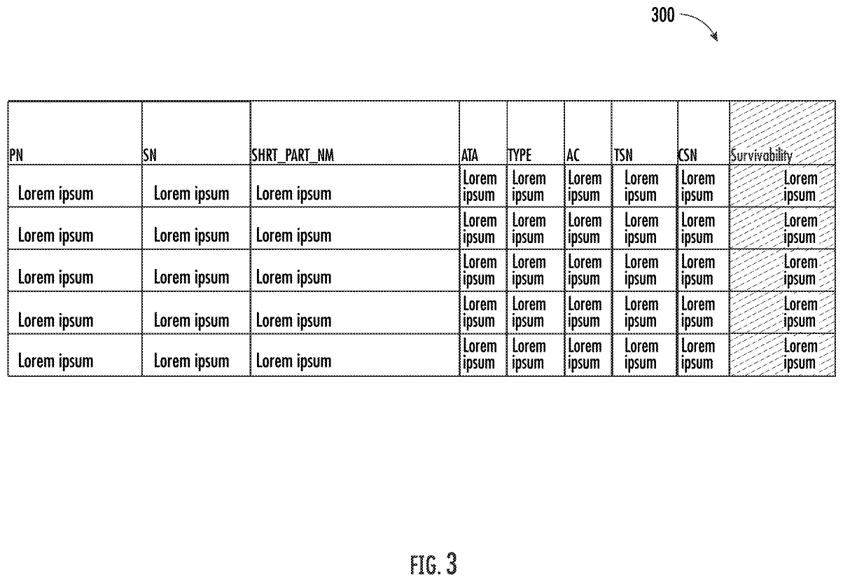

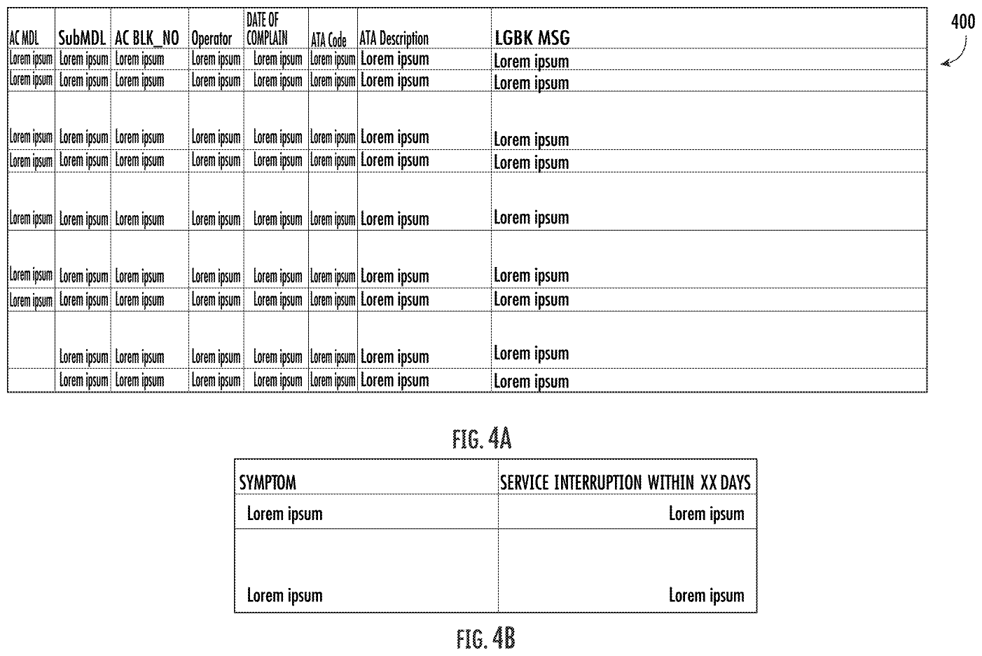

FIGS. 4A and 4B illustrate portions of an aircraft logbook 400, which may be another component of predicting availability of an aircraft according to some example implementations. The aircraft logbook may include a number of messages with data for the aircraft and its parts, such as aircraft model (AC_MDL), aircraft sub-model (AC_SubMDL), aircraft identification (AC_BLK_NO), operator, date of complain, ATA code, ATA description, and/or logbook message (LGBK_MSG), as shown in FIG. 4A. This data, then, may be used to determine symptoms and predict reliability metric values as predictions of service interruption within a certain number of days, as shown in FIG. 4B.

In some more particular examples, the aircraft may include a plurality of sensors and subsystems providing fault and sensor data that is communicated to an aircraft condition monitoring system (ACMS). The ACMS may collect, monitor, record and report real-time aircraft system data, which may include error messages from a flight deck effects (FDE) system, system test reports, fault reports and other information. The ACMS may be in communication with an onboard component/computer such as computer 228. The AHM may reside on this computer, and the computer may provide data acquisition for various data that may include the reliability metric values, or from which the reliability metric values may be determined.

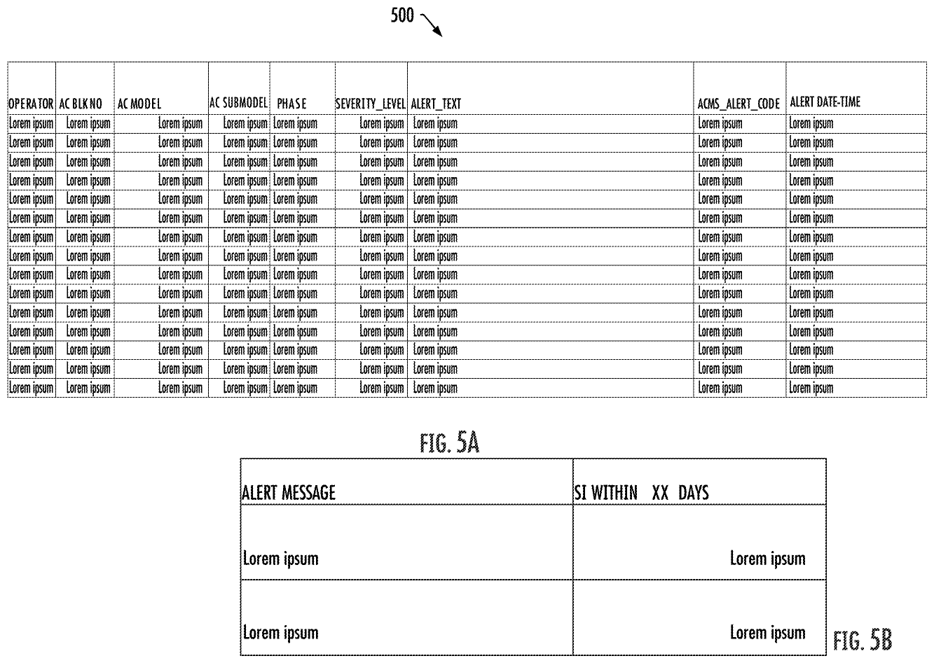

FIGS. 5A and 5B illustrate data 500 from an airplane health management (AHM) system, which may be yet another component of predicting availability of an aircraft according to some example implementations. Similar to the aircraft logbook, data from the AHM may be organized in messages that identify the aircraft by airline, tail number, serial number, major model, sub-modelor the like, as shown in FIG. 5A. The data may also identify a flight phase at which the data was collected, severity level of an alert, a textual description of the alert, ACMS alert code and/or alert time. Also similar to the aircraft logbook, this data may be used to predict reliability metric values as predictions of service interruption within a certain number of days, as shown in FIG. 5B.

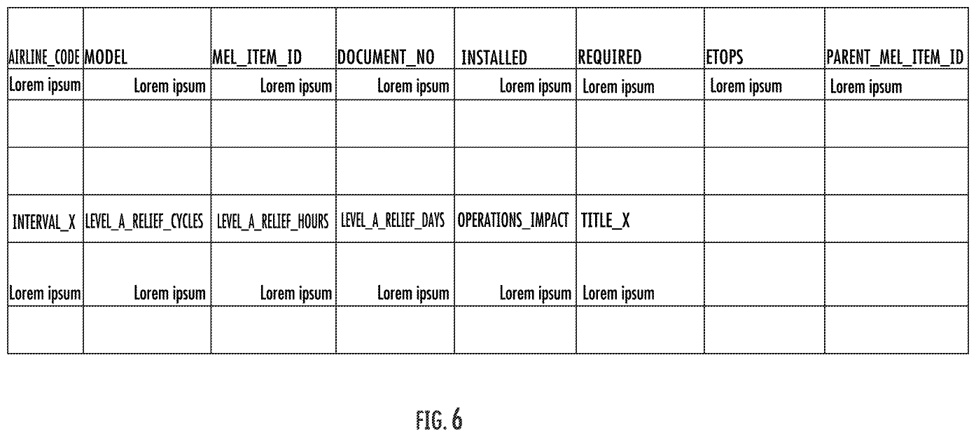

FIG. 6 illustrates a portion of a MEL 600, according to some example implementations. The MEL may include data that specifies required minimum equipment for an aircraft to operate safely for an airline and aircraft model. The data may include operator code, airplane model, MEL item number, document number, number of installed equipment, number of required equipment, ETOPS, parent item number, interval measurement unit, number of cycles before grounded, number of hours before grounded, number of days before grounded, operation impact, and/or title of the MEL

Returning to FIG. 2, the computer 226 is configured to determine availability scores for the aircraft based on the reliability metric values from respective ones of the data sources, each availability score expressing a probability of the aircraft to serve one or more of the flights without an in-service interruption. The computer is configured to combine the availability scores to determine an availability metric value for the aircraft, which in some examples may include the computer configured to weight the availability scores for different ones of the data sources. In this regard, availability scores from the part survival analysis and AHM may be weighted greater than those from the aircraft logbook and MEL.

The computer 226 is configured to dispatch the fleet of aircraft serve the schedule of flights to according to the fleet assignment, or the fleet of aircraft may be dispatched by the operator. In some further examples, the computer is further configured to update the fleet assignment over one or more time intervals (e.g., daily) in which any updates in the reliability metric values are reflected in one or more of the data sources.

More notionally, for example, the computer 226 may access reliability metric values p for parts k=1, . . . L of the i-th aircraft of the fleet of aircraft 230, from the j-th data source or component of availability score. The computer may be configured to determine availability scores sᵢⱼ for the aircraft based on the reliability metric values according to the following:

sᵢⱼ=πₖ₌₁^{L}pₖ^{ij} (1)

In a more particularly in examples in which the j-th data source is a source of part survival analysis, pₖ^{ij} may represent the survivability of the k-th part of the i-th aircraft in the fleet.

After determining the availability scores sᵢⱼ, the computer 226 may then combine the availability scores to determine an availability metric value Aᵢ as follows:

Aᵢ=Σⱼ₌₁^{m}cᵢⱼ×sᵢⱼ (2)

In equation (2), cᵢⱼ represents a coefficient or weight applied to the availability scores for the i-th aircraft and j-th data source.

In some examples, the fleet assignment is performed further based on the airports. In some of these examples, the computer 226 is configured to assign aircraft with lower availability metric values to those of the flights to airports with greater accessibility to maintenance facilities capable of performing maintenance on the aircraft to minimize any in-service interruption caused by a fault or failure of one or more of the parts of the aircraft.

In some examples in which the fleet assignment is performed further based on the airports, the computer 226 is configured to assign aircraft with higher availability metric values to those of the flights to airports with lesser accessibility to maintenance facilities capable of performing maintenance on the aircraft minimize any in-service interruption caused by a fault or failure of one or more of the parts of the aircraft.

Additionally or alternatively, in some examples, the fleet assignment is performed further based on the flights. In some of these examples, the computer 226 is configured to assign aircraft with higher availability metric values longer ones of the flights.

To further illustrate the fleet assignment, consider the following aircraft (identified by tail number) and availability metric values, sorted by availability metric value:

| | Availability |
|---|---|
| Tail | Metric |
| No. | Value |
| X-6 | 99.70% |
| X-1 | 97.50% |
| X-5 | 96.80% |
| X-8 | 94.10% |
| X-3 | 93.50% |
| X-2 | 89.60% |
| X-4 | 85.20% |
| X-7 | 82.50% |

In the above example, the computer 226 may assign the aircraft in the order of least availability metric value (e.g., X-7, X-4, X-2, X-3, X-8, X-5, X-1 and X-6) to those flights to airports with increasing accessibility to maintenance facilities capable of performing maintenance on the aircraft. Similarly, the computer may assign the aircarft in the order of greatest availability metric value (e.g., X-6, X-1, X-5, X-8, X-3, X-2, X-4 and X-7) to those flights to airports with decreasing accessibility to maintenance facilities capable of performing maintenance on the aircraft. Additionally or alternatively, the computer may assign (or factor in the assignment) the aircraft in the order of greatest availability metric value to flights in the order of greatest length.

Although described in the context of a fleet assignment of a fleet of aircraft to a schedule of flights based on availability metric values, it should be understood that the availability metric values may have use without a schedule of flights. That is, some example implementations provide include determining the availability metric value for one or more aircraft, which may be used for a number of purposes including fleet assignment. In other examples, the availability metric value may be used to generate a list of aircraft generally available for a flight, or available for a flight to a particular airport, without a particular schedule of flights.

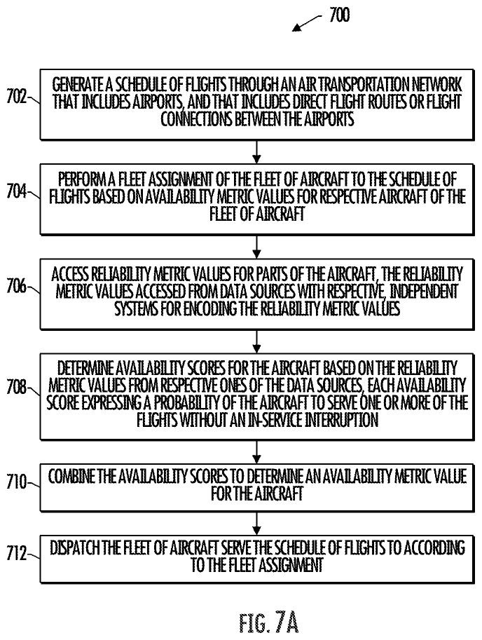

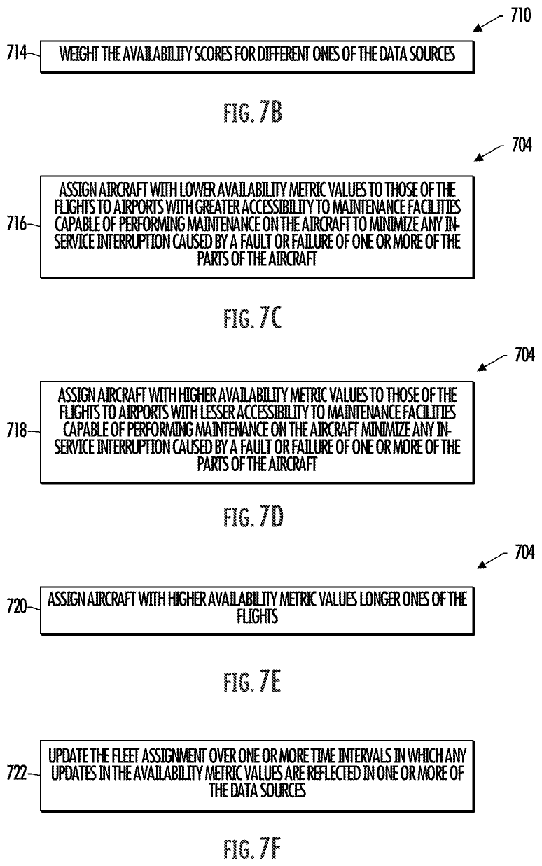

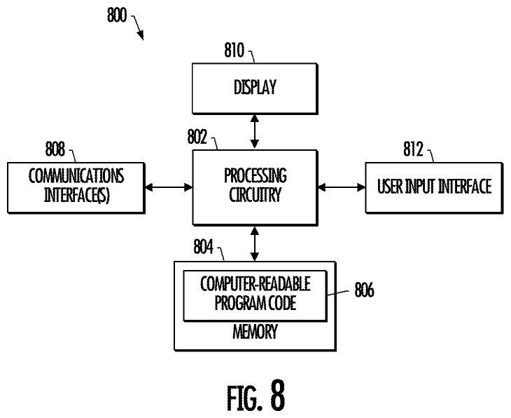

FIGS. 7A-7F are flowcharts illustrating various steps in a method 700 of managing in-service operation of a fleet of aircraft, according to various example implementations of the present disclosure. The method includes generating a schedule of flights through an air transportation network that includes airports, and that includes direct flight routes or flight connections between the airports, as shown at block 702 of FIG. 7A. The method includes performing a fleet assignment of the fleet of aircraft to the schedule of flights based on availability metric values for respective aircraft of the fleet of aircraft, as shown at block 704.

According to example implementations of the present disclosure, performing the fleet assignment includes, for an aircraft of the fleet of aircraft, accessing reliability metric values for parts of the aircraft, the reliability metric values accessed from data sources with respective, independent systems for encoding the reliability metric values, as shown at block 706. In some examples, the reliability metric values are accessed at block 706 from the data sources including multiple ones of a source of part survival analysis, an aircraft logbook, an airplane health management (AHM) system, or a minimum equipment list (MEL).

The method 700 includes determining availability scores for the aircraft based on the reliability metric values from respective ones of the data sources, each availability score expressing a probability of the aircraft to serve one or more of the flights without an in-service interruption, as shown at block 708. The method includes combining the availability scores to determine an availability metric value for the aircraft, as shown at block 710. And the method includes dispatching the fleet of aircraft serve the schedule of flights to according to the fleet assignment, as shown at block 712.

In some examples, combining the availability scores at block 710 includes weighting the availability scores for different ones of the data sources, as shown at block 714 of FIG. 7B.

In some examples, the fleet assignment is performed at block 704 further based on the airports. In some of these examples, the fleet assignment includes assigning aircraft with lower availability metric values to those of the flights to airports with greater accessibility to maintenance facilities capable of performing maintenance on the aircraft to minimize any in-service interruption caused by a fault or failure of one or more of the parts of the aircraft, as shown at block 716 of FIG. 7C.

In some examples in which the fleet assignment is performed at block 704 further based on the airports, the fleet assignment includes assigning aircraft with higher availability metric values to those of the flights to airports with lesser accessibility to maintenance facilities capable of performing maintenance on the aircraft minimize any in-service interruption caused by a fault or failure of one or more of the parts of the aircraft, as shown at block 718 of FIG. 7D.

In some examples, the fleet assignment is performed at block 704 further based on the flights. In some of these examples, the fleet assignment includes assigning aircraft with higher availability metric values longer ones of the flights as shown at block 720 of FIG. 7E.

In some examples, the method 700 further includes updating the fleet assignment over one or more time intervals in which any updates in the reliability metric values are reflected in one or more of the data sources, as shown at block 722 of FIG. 7F.

Example implementations of the present disclosure may be implemented by various means. These means may include computer hardware, alone or under direction of one or more computer programs from a computer-readable storage medium. In some examples, one or more apparatuses such as one or more of the computers 216-228 may be configured to implement example implementations of the present disclosure. In examples involving more than one apparatus, the respective apparatuses may be connected to or otherwise in communication with one another in a number of different manners, such as directly or indirectly via a wired or wireless network or the like.

FIG. 8 illustrates an apparatus 800 according to some example implementations of the present disclosure. Generally, an apparatus of exemplary implementations of the present disclosure may comprise, include or be embodied in one or more fixed or portable electronic devices. Examples of suitable electronic devices include a smartphone, tablet computer, laptop computer, desktop computer, workstation computer, server computer or the like. The apparatus may include one or more of each of a number of components such as, for example, processing circuitry 802 (e.g., processor unit) connected to a memory 804 (e.g., storage device).

The processing circuitry 802 may be composed of one or more processors alone or in combination with one or more memories. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). The processing circuitry may be configured to execute computer programs, which may be stored onboard the processing circuitry or otherwise stored in the memory 804 (of the same or another apparatus).

The processing circuitry 802 may be a number of processors, a multi-core processor or some other type of processor, depending on the particular implementation. Further, the processing circuitry may be implemented using a number of heterogeneous processor systems in which a main processor is present with one or more secondary processors on a single chip. As another illustrative example, the processing circuitry may be a symmetric multi-processor system containing multiple processors of the same type. In yet another example, the processing circuitry may be embodied as or otherwise include one or more ASICs, FPGAs or the like. Thus, although the processing circuitry may be capable of executing a computer program to perform one or more functions, the processing circuitry of various examples may be capable of performing one or more functions without the aid of a computer program. In either instance, the processing circuitry may be appropriately programmed to perform functions or operations according to example implementations of the present disclosure.

The memory 804 is generally any piece of computer hardware that is capable of storing information such as, for example, data, computer programs (e.g., computer-readable program code 806) and/or other suitable information either on a temporary basis and/or a permanent basis. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk—read only memory (CD-ROM), compact disk—read/write (CD-R/W), DVD or the like. In various instances, the memory may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

In addition to the memory 804, the processing circuitry 802 may also be connected to one or more interfaces for displaying, transmitting and/or receiving information. The interfaces may include a communications interface 808 (e.g., communications unit) and/or one or more user interfaces. The communications interface may be configured to transmit and/or receive information, such as to and/or from other apparatus(es), network(s) or the like. The communications interface may be configured to transmit and/or receive information by physical (wired) and/or wireless communications links. Examples of suitable communication interfaces include a network interface controller (NIC), wireless NIC (WNIC) or the like.

The user interfaces may include a display 810 and/or one or more user input interfaces 812 (e.g., input/output unit). The display may be configured to present or otherwise display information to a user, suitable examples of which include a liquid crystal display (LCD), light-emitting diode display (LED), plasma display panel (PDP) or the like. The user input interfaces may be wired or wireless, and may be configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen), biometric sensor or the like. The user interfaces may further include one or more interfaces for communicating with peripherals such as printers, scanners or the like.

As indicated above, program code instructions may be stored in memory, and executed by processing circuitry that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, a processing circuitry or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processing circuitry or other programmable apparatus to configure the computer, processing circuitry or other programmable apparatus to execute operations to be performed on or by the computer, processing circuitry or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

Execution of instructions by a processing circuitry, or storage of instructions in a computer-readable storage medium, supports combinations of operations for performing the specified functions. In this manner, an apparatus 800 may include a processing circuitry 802 and a computer-readable storage medium or memory 804 coupled to the processing circuitry, where the processing circuitry is configured to execute computer-readable program code 806 stored in the memory. It will also be understood that one or more functions, and combinations of functions, may be implemented by special purpose hardware-based computer systems and/or processing circuitry which perform the specified functions, or combinations of special purpose hardware and program code instructions.

As explained above and reiterated below, the present disclosure includes, without limitation, the following example implementations.

Clause 1. An apparatus for managing in-service operation of a fleet of aircraft, the apparatus comprising: a memory configured to store computer-readable program code; and processing circuitry configured to access the memory, and execute the computer-readable program code to cause the apparatus to at least: generate a schedule of flights through an air transportation network that includes airports, and that includes direct flight routes or flight connections between the airports; and perform a fleet assignment of the fleet of aircraft to the schedule of flights based on availability metric values for respective aircraft of the fleet of aircraft, performing the fleet assignment including for an aircraft of the fleet of aircraft: access reliability metric values for parts of the aircraft, the reliability metric values accessed from data sources with respective, independent systems for encoding the reliability metric values; determine availability scores for the aircraft based on the reliability metric values from respective ones of the data sources, each availability score expressing a probability of the aircraft to serve one or more of the flights without an in-service interruption; and combine the availability scores to determine an availability metric value for the aircraft.

Clause 2. The apparatus of clause 1, wherein the processing circuitry is configured to execute the computer-readable program code to cause the apparatus to further dispatch the fleet of aircraft serve the schedule of flights to according to the fleet assignment.

Clause 3. The apparatus of clause 1 or clause 2, wherein the reliability metric values are accessed from the data sources including multiple ones of a source of part survival analysis, an aircraft logbook, an airplane health management (AHM) system, or a minimum equipment list (MEL)

Clause 4. The apparatus of any of clauses 1 to 3, wherein the apparatus caused to combine the availability scores includes the apparatus caused to weight the availability scores for different ones of the data sources.

Clause 5. The apparatus of any of clauses 1 to 4, wherein the fleet assignment is performed further based on the airports, including the apparatus caused to assign aircraft with lower availability metric values to those of the flights to airports with greater accessibility to maintenance facilities capable of performing maintenance on the aircraft to minimize any in-service interruption caused by a fault or failure of one or more of the parts of the aircraft.

Clause 6. The apparatus of any of clauses 1 to 5, wherein the fleet assignment is performed further based on the airports, including the apparatus caused to assign aircraft with higher availability metric values to those of the flights to airports with lesser accessibility to maintenance facilities capable of performing maintenance on the aircraft minimize any in-service interruption caused by a fault or failure of one or more of the parts of the aircraft.

Clause 7. The apparatus of any of clauses 1 to 6, wherein the fleet assignment is performed further based on the flights, including the apparatus caused to assign aircraft with higher availability metric values longer ones of the flights.

Clause 8. The apparatus of any of clauses 1 to 7, wherein the processing circuitry is configured to execute the computer-readable program code to cause the apparatus to further update the fleet assignment over one or more time intervals in which any updates in the reliability metric values are reflected in one or more of the data sources.

Clause 9. A method of managing in-service operation of a fleet of aircraft, the method comprising: generating a schedule of flights through an air transportation network that includes airports, and that includes direct flight routes or flight connections between the airports; and performing a fleet assignment of the fleet of aircraft to the schedule of flights based on availability metric values for respective aircraft of the fleet of aircraft, performing the fleet assignment including for an aircraft of the fleet of aircraft: accessing reliability metric values for parts of the aircraft, the reliability metric values accessed from data sources with respective, independent systems for encoding the reliability metric values; determining availability scores for the aircraft based on the reliability metric values from respective ones of the data sources, each availability score expressing a probability of the aircraft to serve one or more of the flights without an in-service interruption; and combining the availability scores to determine an availability metric value for the aircraft.

Clause 10. The method of clause 9, wherein the method further comprises dispatching the fleet of aircraft serve the schedule of flights to according to the fleet assignment.

Clause 11. The method of clause 9 or clause 10, wherein the reliability metric values are accessed from the data sources including multiple ones of a source of part survival analysis, an aircraft logbook, an airplane health management (AHM) system, or a minimum equipment list (MEL)

Clause 12. The method of any of clauses 9 to 11, wherein combining the availability scores includes weighting the availability scores for different ones of the data sources.

Clause 13. The method of any of clauses 9 to 12, wherein the fleet assignment is performed further based on the airports, including assigning aircraft with lower availability metric values to those of the flights to airports with greater accessibility to maintenance facilities capable of performing maintenance on the aircraft to minimize any in-service interruption caused by a fault or failure of one or more of the parts of the aircraft.

Clause 14. The method of any of clauses 9 to 13, wherein the fleet assignment is performed further based on the airports, including assigning aircraft with higher availability metric values to those of the flights to airports with lesser accessibility to maintenance facilities capable of performing maintenance on the aircraft minimize any in-service interruption caused by a fault or failure of one or more of the parts of the aircraft.

Clause 15. The method of any of clauses 9 to 14, wherein the fleet assignment is performed further based on the flights, including assigning aircraft with higher availability metric values longer ones of the flights.

Clause 16. The method of any of clauses 9 to 15, wherein the method further comprises updating the fleet assignment over one or more time intervals in which any updates in the reliability metric values are reflected in one or more of the data sources.

Clause 17. A computer-readable storage medium for managing in-service operation of a fleet of aircraft, the computer-readable storage medium being non-transitory and having computer-readable program code stored therein that, in response to execution by processing circuitry, causes an apparatus to at least: generate a schedule of flights through an air transportation network that includes airports, and that includes direct flight routes or flight connections between the airports; and perform a fleet assignment of the fleet of aircraft to the schedule of flights based on availability metric values for respective aircraft of the fleet of aircraft, performing the fleet assignment including for an aircraft of the fleet of aircraft: access reliability metric values for parts of the aircraft, the reliability metric values accessed from data sources with respective, independent systems for encoding the reliability metric values; determine availability scores for the aircraft based on the reliability metric values from respective ones of the data sources, each availability score expressing a probability of the aircraft to serve one or more of the flights without an in-service interruption; and combine the availability scores to determine an availability metric value for the aircraft.

Clause 18. The computer-readable storage medium of clause 17, wherein the computer-readable storage medium has further computer-readable program code stored therein that, in response to execution by the processing circuitry, causes the apparatus to further dispatch the fleet of aircraft serve the schedule of flights to according to the fleet assignment.

Clause 19. The computer-readable storage medium of clause 17 or clause 18, wherein the reliability metric values are accessed from the data sources including multiple ones of a source of part survival analysis, an aircraft logbook, an airplane health management (AHM) system, or a minimum equipment list (MEL).

Clause 20. The computer-readable storage medium of any of clauses 17 to 19, wherein the apparatus caused to combine the availability scores includes the apparatus caused to weight the availability scores for different ones of the data sources.

Clause 21. The computer-readable storage medium of any of clauses 17 to 20, wherein the fleet assignment is performed further based on the airports, including the apparatus caused to assign aircraft with lower availability metric values to those of the flights to airports with greater accessibility to maintenance facilities capable of performing maintenance on the aircraft to minimize any in-service interruption caused by a fault or failure of one or more of the parts of the aircraft.

Clause 22. The computer-readable storage medium of any of clauses 17 to 21, wherein the fleet assignment is performed further based on the airports, including the apparatus caused to assign aircraft with higher availability metric values to those of the flights to airports with lesser accessibility to maintenance facilities capable of performing maintenance on the aircraft minimize any in-service interruption caused by a fault or failure of one or more of the parts of the aircraft.

Clause 23. The computer-readable storage medium of any of clauses 17 to 22, wherein the fleet assignment is performed further based on the flights, including the apparatus caused to assign aircraft with higher availability metric values longer ones of the flights.

Clause 24. The computer-readable storage medium of any of clauses 17 to 23, wherein the computer-readable storage medium has further computer-readable program code stored therein that, in response to execution by the processing circuitry, causes the apparatus to further update the fleet assignment over one or more time intervals in which any updates in the reliability metric values are reflected in one or more of the data sources.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus for managing in-service operation of a fleet of aircraft, the apparatus comprising:
a memory configured to store computer-readable program code; and
processing circuitry configured to access the memory, and execute the computer-readable program code to cause the apparatus to at least:
generate a schedule of flights through an air transportation network that includes airports, and that includes direct flight routes or flight connections between the airports; and
perform a fleet assignment of the fleet of aircraft to the schedule of flights based on availability metric values for respective aircraft of the fleet of aircraft, performing the fleet assignment including for an aircraft of the fleet of aircraft:
access reliability metric values for parts of the aircraft, the reliability metric values accessed from data sources with respective, independent systems for encoding the reliability metric values;
determine availability scores for the aircraft based on the reliability metric values from respective ones of the data sources, each availability score expressing a probability of the aircraft to serve one or more of the flights without an in-service interruption; and
combine the availability scores to determine an availability metric value for the aircraft.

2. The apparatus of claim 1, wherein the processing circuitry is configured to execute the computer-readable program code to cause the apparatus to further dispatch the fleet of aircraft serve the schedule of flights to according to the fleet assignment.

3. The apparatus of claim 1, wherein the reliability metric values are accessed from the data sources including multiple ones of a source of part survival analysis, an aircraft logbook, an airplane health management (AHM) system, or a minimum equipment list (MEL).

4. The apparatus of claim 1, wherein the apparatus caused to combine the availability scores includes the apparatus caused to weight the availability scores for different ones of the data sources.

5. The apparatus of claim 1, wherein the fleet assignment is performed further based on the airports, including the apparatus caused to assign aircraft with lower availability metric values to those of the flights to airports with greater accessibility to maintenance facilities capable of performing maintenance on the aircraft to minimize any in-service interruption caused by a fault or failure of one or more of the parts of the aircraft.

6. The apparatus of claim 1, wherein the fleet assignment is performed further based on the airports, including the apparatus caused to assign aircraft with higher availability metric values to those of the flights to airports with lesser accessibility to maintenance facilities capable of performing maintenance on the aircraft minimize any in-service interruption caused by a fault or failure of one or more of the parts of the aircraft.

7. The apparatus of claim 1, wherein the fleet assignment is performed further based on the flights, including the apparatus caused to assign aircraft with higher availability metric values longer ones of the flights.

8. The apparatus of claim 1, wherein the processing circuitry is configured to execute the computer-readable program code to cause the apparatus to further update the fleet assignment over one or more time intervals in which any updates in the reliability metric values are reflected in one or more of the data sources.

9. A method of managing in-service operation of a fleet of aircraft, the method comprising:
generating a schedule of flights through an air transportation network that includes airports, and that includes direct flight routes or flight connections between the airports; and
performing a fleet assignment of the fleet of aircraft to the schedule of flights based on availability metric values for respective aircraft of the fleet of aircraft, performing the fleet assignment including for an aircraft of the fleet of aircraft:
accessing reliability metric values for parts of the aircraft, the reliability metric values accessed from data sources with respective, independent systems for encoding the reliability metric values;
determining availability scores for the aircraft based on the reliability metric values from respective ones of the data sources, each availability score expressing a probability of the aircraft to serve one or more of the flights without an in-service interruption; and
combining the availability scores to determine an availability metric value for the aircraft.

10. The method of claim 9, wherein the method further comprises dispatching the fleet of aircraft serve the schedule of flights to according to the fleet assignment.

11. The method of claim 9, wherein the reliability metric values are accessed from the data sources including multiple ones of a source of part survival analysis, an aircraft logbook, an airplane health management (AHM) system, or a minimum equipment list (MEL).

12. The method of claim 9, wherein combining the availability scores includes weighting the availability scores for different ones of the data sources.

13. The method of claim 9, wherein the fleet assignment is performed further based on the airports, including assigning aircraft with lower availability metric values to those of the flights to airports with greater accessibility to maintenance facilities capable of performing maintenance on the aircraft to minimize any in-service interruption caused by a fault or failure of one or more of the parts of the aircraft.

14. The method of claim 9, wherein the fleet assignment is performed further based on the airports, including assigning aircraft with higher availability metric values to those of the flights to airports with lesser accessibility to maintenance facilities capable of performing maintenance on the aircraft minimize any in-service interruption caused by a fault or failure of one or more of the parts of the aircraft.

15. The method of claim 9, wherein the fleet assignment is performed further based on the flights, including assigning aircraft with higher availability metric values longer ones of the flights.

16. The method of claim 9, wherein the method further comprises updating the fleet assignment over one or more time intervals in which any updates in the reliability metric values are reflected in one or more of the data sources.

17. A computer-readable storage medium for managing in-service operation of a fleet of aircraft, the computer-readable storage medium being non-transitory and having computer-readable program code stored therein that, in response to execution by processing circuitry, causes an apparatus to at least:
generate a schedule of flights through an air transportation network that includes airports, and that includes direct flight routes or flight connections between the airports; and
perform a fleet assignment of the fleet of aircraft to the schedule of flights based on availability metric values for respective aircraft of the fleet of aircraft, performing the fleet assignment including for an aircraft of the fleet of aircraft:
access reliability metric values for parts of the aircraft, the reliability metric values accessed from data sources with respective, independent systems for encoding the reliability metric values;
determine availability scores for the aircraft based on the reliability metric values from respective ones of the data sources, each availability score expressing a probability of the aircraft to serve one or more of the flights without an in-service interruption; and
combine the availability scores to determine an availability metric value for the aircraft.

18. The computer-readable storage medium of claim 17, wherein the computer-readable storage medium has further computer-readable program code stored therein that, in response to execution by the processing circuitry, causes the apparatus to further dispatch the fleet of aircraft serve the schedule of flights to according to the fleet assignment.

19. The computer-readable storage medium of claim 17, wherein the reliability metric values are accessed from the data sources including multiple ones of a source of part survival analysis, an aircraft logbook, an airplane health management (AHM) system, or a minimum equipment list (MEL).

20. The computer-readable storage medium of claim 17, wherein the apparatus caused to combine the availability scores includes the apparatus caused to weight the availability scores for different ones of the data sources.

21. The computer-readable storage medium of claim 17, wherein the fleet assignment is performed further based on the airports, including the apparatus caused to assign aircraft with lower availability metric values to those of the flights to airports with greater accessibility to maintenance facilities capable of performing maintenance on the aircraft to minimize any in-service interruption caused by a fault or failure of one or more of the parts of the aircraft.

22. The computer-readable storage medium of claim 17, wherein the fleet assignment is performed further based on the airports, including the apparatus caused to assign aircraft with higher availability metric values to those of the flights to airports with lesser accessibility to maintenance facilities capable of performing maintenance on the aircraft minimize any in-service interruption caused by a fault or failure of one or more of the parts of the aircraft.

23. The computer-readable storage medium of claim 17, wherein the fleet assignment is performed further based on the flights, including the apparatus caused to assign aircraft with higher availability metric values longer ones of the flights.

24. The computer-readable storage medium of claim 17, wherein the computer-readable storage medium has further computer-readable program code stored therein that, in response to execution by the processing circuitry, causes the apparatus to further update the fleet assignment over one or more time intervals in which any updates in the reliability metric values are reflected in one or more of the data sources.
